(19) United States
(12) Patent Application Publication
(10) Pub. No.: US 2023/0406754 A1
(43) Pub. Date: Dec. 21, 2023

(54) GLASS AND MANUFACTURING METHOD THEREOF

(71) Applicant: NIPPON ELECTRIC GLASS CO., LTD., Otsu-shi, Shiga (JP)

(72) Inventors: Tamio ANDO, Otsu-shi, Shiga (JP); Shunsuke FUJITA, Otsu-shi, Shiga (JP)

(73) Assignee: NIPPON ELECTRIC GLASS CO., LTD., Otsu-shi, Shiga (JP)

(21) Appl. No.: 18/035,405

(22) PCT Filed: Dec. 23, 2021
(86) PCT No.: PCT/JP2021/047906

§ 371 Date: May 4, 2023

(30) Foreign Application Priority Data
Dec. 29, 2020 (JP) 2020-219760

(51) Int. Cl. C03C 3/097; C08K 7/20; B29C 64/124

(52) U.S. Cl. CPC C03C 3/097; C08K 7/20; B29C 64/124; C03C 2203/10; C08K 2201/005; B29K 2509/08

(57) ABSTRACT

The glass contains a Ti component in a glass composition, in which a Ti³⁺ ion content is 80 ppm or less.

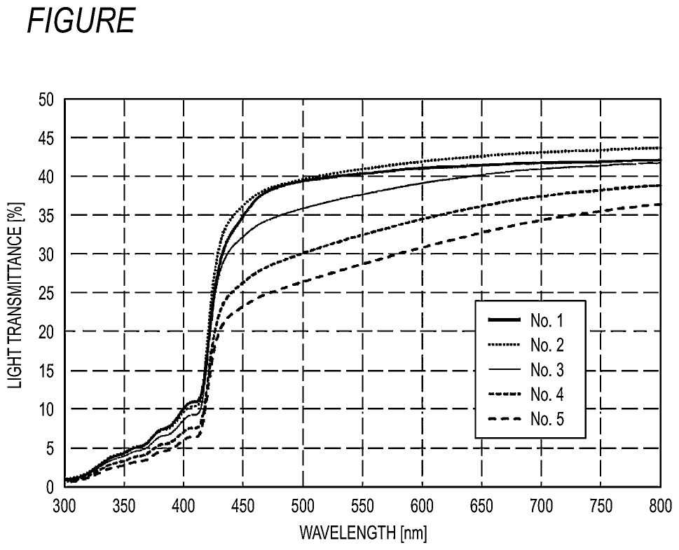

### TECHNICAL FIELD

The present invention relates to a glass suitable for dental materials and the like and a manufacturing method of the glass.

### BACKGROUND ART

A dental resin composition, which is a mixture of a resin and an inorganic filler, has been used for applications such as a dental restorative material, a denture base, a crown, and a temporary crown, in a related art. Usually, a UV-curable resin is used in dental resin compositions. For example, in the case of a dental restorative material, treatment is performed by applying a dental resin composition to a treatment site on a tooth and then irradiating the dental resin composition with UV light to cure the dental resin composition. Here, from the viewpoint of improving the aesthetic appearance of teeth after treatment, a glass filler with high light transmission properties has been proposed as the inorganic filler (see, for example, Patent Document 1)

### CITATION LIST

### Patent Literature

Patent Document 1: JP 2010-202560 A

### SUMMARY OF INVENTION

### Technical Problem

Even when a glass filler is used as the inorganic filler in applications such as a dental resin composition, desired light transmission properties may still not be achieved.

In view of the above, an object of the present invention is to provide a glass with excellent light transmission properties that is suitable for applications such as a dental resin composition or the like, a manufacturing method of the glass, and the like.

### Solution to Problem

As a result of intensive studies, the present inventors found that light transmittance decreases due to a specific component in glass, and that desired light transmission properties can be achieved by limiting the content of the specific component.

That is, the glass according to an embodiment of the present invention is a glass containing a Ti component in the glass composition, in which a Ti³⁺ ion content is 80 ppm or less. As a result of investigations, the present inventors found that in a glass containing a Ti component in the glass composition, the Ti³⁺ ions in the Ti component cause coloration. As such, in a glass containing a Ti component in the glass composition, unsuitable coloration can be suppressed by limiting the Ti³⁺ ion content, which affect coloration, in accordance with the description above, making it possible to achieve desired light transmission properties.

The glass according to an embodiment of the present invention preferably contains 0.1 mass % or greater of TiO₂. In this case, the effect of the present invention is easily achieved.

The glass according to an embodiment of the present invention may further contain an Fe component. When the Ti³⁺ ions in the glass composition coexist with the Fe component, coloration tends to be intensified. As such, in the glass containing both the Ti component and the Fe component in the glass composition, the effect of the present invention is easily achieved.

The glass according to an embodiment of the present invention may contain the Fe component in an amount of 10 ppm or greater as calculated as Fe₂O₃. In this case, the effect of the present invention is easily achieved.

The glass according to an embodiment of the present invention preferably contains from 30 to 80 mass % of SiO₂, from 0 to 30 mass % of Al₂O₃, from 0 to 30 mass % of B₂O₃, from 0 to 25 mass % of CaO, from 0 to 30 mass % of Na₂O, from 0 to 30 mass % of K₂O, from 0 to 10 mass % of Li₂O, from 0.1 to 15 mass % of TiO₂, from 0 to 20 mass % of Nb₂O₅, from 0 to 20 mass % of WO₃, and from 0 to 10 mass % of F.

The glass according to an embodiment of the present invention is preferably particulate. This makes it easy to evenly contain the glass as a filler in the resin composition and to improve the mechanical strength of a molded body made of a cured product of the resin composition.

The glass according to an embodiment of the present invention is preferably substantially spherical. This makes it difficult to increase the viscosity of the resin composition, giving the resin composition excellent fluidity and making the resin composition easy to handle. In addition, this makes it possible to contain the glass in the resin composition at a high concentration, making it easy to increase the mechanical strength of a molded body made of a cured product of the resin composition.

The glass according to an embodiment of the present invention preferably has an average particle size from 0.5 to 50 μm.

A manufacturing method of a glass according to an embodiment of the present invention is a method for manufacturing the above-described glass, the manufacturing method including: preparing a precursor glass by melting raw materials and forming; and heat-treating the precursor glass at a temperature within ±300° C. of a glass transition point. In this way, a precursor glass is first prepared, and then the precursor glass is heat-treated at a predetermined temperature. This can reduce the Ti³⁺ ion content in the glass. As a result, coloration due to the Ti³⁺ ions can be reduced.

A resin composition according to an embodiment of the present invention contains a curable resin and the above-described glass.

The resin composition according to an embodiment of the present invention preferably contains from 1 to 70 vol % of the glass.

The resin composition according to an embodiment of the present invention is preferably for dental use.

A molded body according to an embodiment of the present invention is made of a cured product of the above-described resin composition.

A manufacturing method of a molded body according to an embodiment of the present invention includes curing a resin composition by irradiating a light beam to the resin composition, in which the resin composition is the above-mentioned resin composition.

A manufacturing method of a molded body according to an embodiment of the present invention includes forming a cured product layer by selectively irradiating a light beam to a liquid layer made of a resin composition, the cured product layer having a predetermined pattern; after forming a new liquid layer on the cured product layer, forming a new cured product layer by irradiating the light beam to the new liquid layer, the new cured product layer having a predetermined pattern continuous with the cured product layer; and repeating stacking of the cured product layers until a predetermined molded body is produced, in which the resin composition is the above-mentioned resin composition.

### Advantageous Effects of Invention

The present invention provides a glass with excellent light transmission properties that is suitable for applications such as a dental resin composition or the like.

### BRIEF DESCRIPTION OF DRAWINGS

The FIGURE is a graph illustrating a light transmittance curve of a molded body prepared in Examples.

### DESCRIPTION OF EMBODIMENTS

Hereinafter, a glass and the like according to an embodiment of the present invention will be described in detail. Note that, in the description regarding the content of each component of the glass, “%” means “mass %” unless otherwise indicated.

Glass A glass according to an embodiment of the present invention contains a Ti component in the glass composition.

The glass according to an embodiment of the present invention contains, for example, TiO₂ as the Ti component. TiO₂ is a component that tends to increase the refractive index and lower the Abbe's number. The content of the TiO₂ is preferably 0.1 mass % or greater, 0.2 mass % or greater, or 0.5 mass % or greater, and particularly preferably 1 mass % or greater. However, when the TiO₂ content is too large, softening point tends to go up. In addition, light transmittance tends to deteriorate. As such, the TiO₂ content is preferably 15 mass % or less, 10 mass % or less, or 5 mass % or less, and particularly preferably 3.5 mass % or less.

In a glass, a Ti component is mainly present as Ti³⁺ and Ti⁴⁺. As described above, the Ti³⁺ ions in the Ti component cause coloration. As such, the content of Ti³⁺ ions is preferably 80 ppm or less, 60 ppm or less, or 30 ppm or less, and particularly preferably 20 ppm or less. The lower limit of the content of Ti³⁺ ions, although not limited, is practically 0.1 ppm or greater. Note that, the ratio of the Ti³⁺ content to the Ti element in the glass (Ti³⁺/Total Ti) is preferably 0.007 or less, or 0.005 or less, and particularly preferably 0.0025 or less. The lower limit of Ti³⁺/Total Ti is not limited, but is practically 0.000008 or greater.

As described above, when the Ti³⁺ ions in the glass composition coexist with the Fe component, coloration tends to be intensified. As such, in the glass containing both the Ti component and the Fe component in the glass composition, the effect of the present invention is easily achieved. The content of the Fe component in the glass according to an embodiment of the present invention is preferably, as calculated as Fe₂O₃, 10 ppm or greater, or 20 ppm or greater, and particularly preferably 30 ppm or greater. When the Fe component is contained in a predetermined amount as described above, coloration due to coexistence with the Ti³⁺ ions is likely to occur, and thus the effect of the present invention is easily achieved. The upper limit of the content of the Fe component is not limited, but is, as calculated as Fe₂O₃, preferably less than 1000 ppm, or 500 ppm or less, and particularly preferably 100 ppm or less, because an excessively large content of the Fe component tends to lead to significant coloration due to the Fe component itself. The Fe component may be actively added as a raw material, or may be mixed in as an impurity of a raw material of another component, or may be mixed into the glass during the manufacturing process.

A specific example of a composition of the glass according to an embodiment of the present invention contains from 30 to 80 mass % of SiO₂, from 0 to 30 mass % of Al₂O₃, from 0 to 30 mass % of B₂O₃, from 0 to 25 mass % of CaO, from 0 to 30 mass % of Na₂O, from 0 to 30 mass % of K₂O, from 0 to 10 mass % of Li₂O, from 0.1 to 15 mass % of TiO₂, from 0 to 20 mass % of Nb₂O₅, from 0 to 20 mass % of WO₃, and from 0 to 10 mass % of F. The reason for limiting the glass composition in this manner will be described below. Note that, since the reason pertaining to TiO₂ is as described above, description thereof will be omitted.

SiO₂ is a component that forms a glass network. It is also a component that has the effect of improving chemical durability and suppressing devitrification. The content of SiO₂ is preferably from 30% to 80%, from 35% to 73%, from 40% to 70%, or from 50% to 70%, and particularly preferably from 51% to 65%. When the SiO₂ content is too small, chemical durability tends to deteriorate; moreover, the glass tends to devitrify, which may make the manufacturing difficult. Meanwhile, when the SiO₂ content is too large, meltability tends to deteriorate.

Al₂O₃ is a vitrification stabilizing component. It is also a component that has the effect of improving chemical durability and suppressing devitrification. The content of Al₂O₃ is preferably from 0% to 30%, from 1% to 20%, from 2% to 20%, from 5% to 20%, from 10% to 20%, or from 11% to 20%, and particularly preferably greater than 15% and 20% or less. When the Al₂O₃ content is too small, chemical durability tends to deteriorate; moreover, the glass tends to devitrify, which may make the manufacturing difficult. Meanwhile, when the Al₂O₃ content is too large, meltability tends to deteriorate.

B₂O₃ is a component that forms a glass network. It is also a component that has the effect of improving chemical durability and suppressing devitrification. The content of B₂O₃ is preferably from 0% to 30%, from 1% to 27.5%, from 2% to 25%, from 5% to 25%, or from 10% to 25%, and particularly preferably from 11% to 20%. When the B₂O₃ content is too large, meltability tends to deteriorate.

CaO is a component that stabilizes vitrification as an intermediate. In addition, it is a component that tends to reduce the viscosity of the glass without significantly reducing the chemical durability of the glass. The content of CaO is preferably from 0% to 25%, from 0% to 20%, from 0.1% to 15%, from 0.5% to 10%, from 1% to 9%, or from 1% to 5%, and particularly preferably from 1% to 4%. When the CaO content is too large, chemical durability tends to deteriorate; moreover, the glass tends to devitrify, which may make the manufacturing difficult.

Na₂O is a component that reduces the viscosity of glass and suppresses devitrification. The content of Na₂O is preferably from 0% to 30%, from 0.1% to 25%, or from 0.5% to 20%, and particularly preferably from 1% to 15%. When the Na₂O content is too large, chemical durability tends to deteriorate; moreover, the glass tends to devitrify, which may make the manufacturing difficult.

K₂O is a component that reduces the viscosity of glass and suppresses devitrification. The content of K₂O is preferably from 0% to 30%, from 0.1% to 25%, or from 0.5% to 20%, and particularly preferably from 1% to 15%. When the K₂O content is too large, chemical durability tends to deteriorate; moreover, the glass tends to devitrify, which may make the manufacturing difficult.

Li₂O is a component that reduces the viscosity of glass and suppresses devitrification. The content of Li₂O is preferably from 0% to 10%, from 0.1% to 9%, or from 0.5% to 7%, and particularly preferably from 1% to 5%. When the Li₂O content is too large, chemical durability tends to deteriorate; moreover, the glass tends to devitrify, which may make the manufacturing difficult. When the Li₂O content is too small, meltability tends to deteriorate.

Nb₂O₅ is a component capable of adjusting the refractive index and the Abbe number. The content of Nb₂O₅ is preferably from 0% to 20%, from 0.1% to 15%, or from 0.5% to 10%, and particularly preferably from 1% to 5%. When the Nb₂O₅ content is too large, the glass tends to devitrify.

WO₃ is a component capable of adjusting the refractive index and the Abbe number, and is a component that reduces the viscosity of the glass. The content of WO₃ is preferably from 0% to 20%, from 0.1% to 15%, or from 0.5% to 10%, and particularly preferably from 1% to 5%. When the WO₃ content is too large, the glass tends to devitrify.

The sum of the contents of Nb₂O₅ and WO₃ in the glass composition is preferably from 0% to 30%, from 0.1% to 25%, or from 1% to 20%, and particularly preferably from 2% to 10%. When these components are within the range described above, the refractive index and the Abbe number are easily adjusted, and coloration is less likely to occur. Moreover, devitrification of the glass is easily suppressed. Furthermore, a glass with high chemical durability is easily obtained.

In addition, the sum of the contents of TiO₂, Nb₂O₅, and WO₃ is preferably from 0% to 30%, from 0.1% to 25%, or from 1% to 20%, and particularly preferably from 3% to 15%. When the contents of these components are within the range described above, the refractive index and the Abbe's number are easily adjustable, and devitrification of the glass is easily suppressed. Furthermore, a glass with high chemical durability is easily obtained.

F is a component that forms a glass network. It is also a component that can increase light transmittance, particularly light transmittance in the ultraviolet region. Further, it is a component that can adjust the refractive index and the Abbe's number. The content of F is preferably from 0% to 10%, from 0.1% to 7.5%, or from 0.5% to 5%, and particularly preferably from 1% to 3%. When the F content is too large, chemical durability tends to deteriorate. Furthermore, since F is highly volatile, the volatilized component may adhere to the glass surface during bead production and deteriorate the surface properties.

In addition to the components described above, the glass according to an embodiment of the present invention may also contain the following components.

MgO, SrO, BaO, and ZnO are components that, similar to CaO, stabilize vitrification as intermediates. In addition, they are components that easily reduce the viscosity of the glass without significantly reducing the chemical durability of the glass. The sum of these components is preferably from 0.1% to 50%, or from 1% to 40%, and particularly preferably from 2% to 30%. The content of each of MgO, SrO, BaO, and ZnO is preferably from 0% to 50%, from 0.1% to 50%, or from 1% to 40%, and particularly preferably from 2% to 30%.

P₂O₅ is a component that forms a glass network and that improves the light transmittance and devitrification resistance of the glass. It is also a component that easily lowers the softening point of the glass. The content of P₂O₅ is preferably from 0% to 5%, or from 0% to 4.5%, and particularly preferably from 0% to 4%. When the P₂O₅ content is too large, the refractive index tends to decrease. In addition, striae are likely to occur.

ZrO₂ is a component that improves weather resistance and that increases the refractive index. The content of ZrO₂ is preferably from 0% to 10%, or from 0% to 7.5%, and particularly preferably from 0% to 5%. When the ZrO₂ content is too large, the softening point tends to go up. In addition, devitrification resistance tends to decrease.

NiO, Cr₂O₃, and CuO are components that color the glass and that easily reduce light transmittance, particularly in the ultraviolet region to the visible region. As such, the content of each of these components is preferably 1% or less, 0.75% or less, or 0.5% or less, and particularly preferably substantially not contained.

Sb₂O₃ and CeO₂ are components that tend to suppress a decrease in light transmittance. Moreover, when the contents of these components are too large, devitrification tends to occur. As such, the content of each of Sb₂O₃ and CeO₂ is preferably 1% or less, 0.8% or less, 0.5% or less, or 0.2% or less, and particularly preferably substantially not contained.

Lead components (such as PbO) and arsenic components (such as As₂O₃) are preferably substantially not contained for environmental reasons. In the above description, “substantially not contained” means that the components are not intentionally contained as raw materials, and specifically means that the content of each of the components is less than 0.1%.

The shape of the glass according to an embodiment of the present invention is not limited, but it is preferably particulate because such shape allows the glass to be contained in a resin as a filler and evenly dispersed in the resin. In particular, the shape of the glass according to an embodiment of the present invention is preferably a bead shape because such shape tends to suppress an increase in the viscosity of a resin composition. Note that the term “bead shape” means substantially spherical particles and does not necessarily mean perfectly spherical particles. Note that, in addition to a particle shape, the glass according to an embodiment of the present invention may have a fiber shape or a bulk shape.

When the glass has a particle shape (hereinafter, also referred to as glass particles), the average particle size is preferably from 0.5 to 50 μm, from 0.5 to 40 μm, from 0.5 to 30 μm, from 0.5 to 20 μm, or from 0.5 to 10 μm, and particularly preferably from 0.8 to 6 μm. This makes it easy to improve the surface smoothness of a molded body made of a cured product of the resin composition. When the average particle size of the glass particles is too small, the fluidity of the resin composition decreases, making it difficult for bubbles mixed in the resin composition to escape to the outside. Meanwhile, when the average particle size of the glass particles is too large, the curability of the resin composition tends to decrease.

The refractive index nd of the glass is preferably, for example, from 1.40 to 1.90, or from 1.40 to 1.65, and particularly preferably from 1.45 to 1.6. The Abbe's number νd is preferably, for example, from 20 to 65, or from 30 to 65, and particularly preferably from 40 to 60. In this way, the optical constants are easily matched with those of many curable resins such as acrylic resins and epoxy resins, making it easy to produce a molded body having excellent transparency.

### Glass Manufacturing Method

The glass according to an embodiment of the present invention can be produced by melting raw materials and forming to prepare a precursor glass and then heat-treating the precursor glass.

The melting temperature is not limited and may be a temperature at which the raw materials can be homogeneously melted. For example, the melting temperature is preferably from 1400° C. to 1700° C., and particularly preferably from 1500° C. to 1650° C.

Next, the resulting molten glass is formed into a desired shape, resulting in a precursor glass. For example, in the case of preparing a precursor glass having a particle shape, it is preferable that the molten glass is poured between a pair of cooling rollers and formed into a film shape, and then the resulting film-shaped molded body is ground into a predetermined size, and, as necessary, classification is further performed. Further, by flame polishing the resulting glass particles with an air burner or the like, the glass particles can be softened, fluidized, spheroidized, and formed into a bead shape.

Then, the resulting precursor glass is subjected to a heat treatment, and thus the Ti component in the glass is oxidized, reducing the Ti^{3+ ion content in the glass. As a result, coloration caused by the Ti ions can be reduced. The heat treatment temperature of the precursor glass is preferably within ±}300° C., or within ±200° C., and particularly preferably within ±150° C. of the glass transition point. When the heat treatment temperature of the precursor glass is too low, it is difficult to achieve the effect of reducing the Ti³⁺ ion content in the glass. Meanwhile, when the heat treatment temperature of the precursor glass is too high, the precursor glass may soften and deform, and a glass having a desired shape may not be manufactured. As such, the upper limit of the heat treatment temperature may be equal to or lower than the glass transition point+100° C., equal to or lower than the glass transition point+50° C., or even equal to or lower than the glass transition point.

Note that, when the glass is flame-polished, the glass itself is reduced, and the Ti content in the glass tends to increase. As such, in a case in which flame polishing is included in the glass production process, the effect resulting from applying the present manufacturing method can be easily achieved.

### Resin Composition

A resin composition according to an embodiment of the present invention contains a curable resin and the above-mentioned glass. Specific examples of the curable resin will be described below.

An ultraviolet curable resin is preferably used as the curable resin. The ultraviolet curable resin is preferably a resin resulting from polymerization of radical species or cationic species, such as an acrylic resin or an epoxy resin. Examples of the acrylic resin include an ester acrylate resin and a urethane acrylate resin.

The acrylic resin may include the following compounds. For example, the acrylic resin may include a monofunctional compound, such as isobornyl acrylate, isobornyl methacrylate, dicyclopentenyl acrylate, bornyl acrylate, bornyl methacrylate, 2-hydroxyethyl acrylate, 2-hydroxypropyl acrylate, propylene glycol acrylate, vinylpyrrolidone, acrylamide, vinyl acetate, and styrene. The acrylic resin may include a polyfunctional compound, such as trimethylolpropane triacrylate, EO-modified trimethylolpropane triacrylate, ethylene glycol diacrylate, tetraethylene glycol diacrylate, polyethylene glycol diacrylate, 1,4-butanediol diacrylate, 1,6-hexanediol diacrylate, neopentyl glycol diacrylate, dicyclopentenyl diacrylate, polyester diacrylate, and diallyl phthalate. These monofunctional compounds and polyfunctional compounds may be used alone or in combination of two or more types. However, these compounds are not limited to the description above.

For the acrylic resin, a photopolymerization initiator can be used as a polymerization initiator. Example of the polymerization initiator include 2,2-dimethoxy-2-phenylacetophenone, 1-hydroxycyclohexyl phenyl ketone, acetophenone, benzophenone, xanthone, fluorenone, benzaldehyde, fluorene, anthraquinone, triphenylamine, carbazole, 3-methylacetophenone, and Michler's ketone. These polymerization initiators may be used alone or in combination of two or more types. Each of these polymerization initiators is preferably contained in an amount from 0.1 mass % to 10 mass % with respect to the monofunctional compound and the polyfunctional compound. As necessary, a sensitizer such as an amine compound may be used in combination.

The epoxy resin may include the following compounds. The epoxy resin may include, for example, hydrogenated bisphenol A diglycidyl ether, 3,4-epoxycyclohexylmethyl-3,4-epoxycyclohexane carboxylate, 2-(3,4-epoxycyclohexyl-5,5-spiro-3,4-epoxy)cyclohexane-m-dioxane, and bis(3,4-epoxycyclohexylmethyl)adipate. When these compounds are used, an energy-activated cationic initiator such as triphenylsulfonium hexafluoroantimonate can be used.

Furthermore, a leveling agent, a surfactant, an organic polymer compound, an organic plasticizer, an anti-static agent, and the like may be added to the curable resin as necessary.

The content of glass in the resin composition is preferably from 1 to 70 vol %, from 5 to 65 vol %, or 10 to 60 vol %, and particularly preferably from 15 to 55 vol %. When the content of glass is too small, the mechanical strength of a molded body made of a cured product of the resin composition tends to decrease. Meanwhile, when the content of glass is too large, light scattering increases, and it becomes difficult to produce a molded body having excellent transparency. In addition, the curability of the resin composition tends to decrease. Also, the viscosity of the curable resin tends to be too large, making handling difficult.

The difference between the refractive index nd of the glass and the refractive index nd of the curable resin before curing is preferably within ±0.1, within ±0.09, within +0.08, or within +0.07, and particularly preferably within +0.05. The difference between the Abbe's number νd of the curable resin before curing and the Abbe's number νd of the glass is preferably within +10, or within +9, and particularly preferably within +8. In this way, light scattering due to a difference between the refractive index of the curable resin and the refractive index of the glass in the stage of curing the resin composition can be suppressed. The difference between the refractive index nd of the glass and the refractive index nd of the curable resin after curing is preferably within +0.1, within +0.08, within +0.05, or within +0.03, and particularly preferably within +0.02. In this way, light scattering due to a difference between the refractive index of the resin after curing and the refractive index of the glass can be suppressed, and a molded body having excellent transparency can be easily produced.

### Manufacturing Method of Molded Body

Next, a manufacturing method of a molded body using the resin composition according to an embodiment of the present invention will be described.

A molded body can be produced by irradiating a light beam to the above-described resin composition according to an embodiment of the present invention to cure the resin composition. Here, when an ultraviolet curable resin is used as the resin, ultraviolet rays may be used as the light beam in irradiation. For example, when the resin composition is used as a dental restorative material or the like (so-called dental composite resin), the treatment can be performed by applying the resin composition to a treatment site on a tooth and then irradiating a light beam to the resin composition to cure the resin composition.

The shape of the molded body is not limited, but the use of 3D printing technology is preferable in a case of producing a three-dimensional shaped object having a predetermined shape. This method can manufacture, with high accuracy and ease, a three-dimensional shaped object such as a crown or a temporary crown having a desired shape. Next, an example of a manufacturing method of a three-dimensional shaped object using the resin composition according to an embodiment of the present invention will be described.

First, a liquid layer made of the resin composition is prepared. More specifically, a stage for shaping is provided in a tank filled with the resin composition in a liquid form. At this time, the shaping surface of the stage for shaping is positioned at a desired depth from the liquid surface of the resin composition.

Next, the liquid layer is selectively irradiated with a light beam to form a cured product layer having a predetermined pattern. The cured product layer is formed on the shaping surface.

Next, a new liquid layer is formed on the cured product layer. This means that the resin composition in a liquid form is introduced again onto the cured product layer. For example, the stage for shaping is moved for the equivalent of the depth of one layer, thus introducing the resin composition in a liquid form onto the cured product layer.

Next, the resin composition in a liquid form introduced onto the cured product layer is irradiated with the light beam, forming a new cured product layer having a predetermined pattern continuous with the cured product layer.

The above operations are repeated until a predetermined three-dimensional shaped object is produced. As such, the cured product layers are stacked, resulting in a desired three-dimensional shaped object.

Note that, in addition to being used for dental material applications, the resin composition according to an embodiment of the present invention can also be suitably used as a resin composition for optical members and the like.

### Examples

Hereinafter, the present invention will be described based on Examples, but the present invention is not limited to Examples below.

### Production of Glass Particles

Raw material powders were evenly mixed in a ratio of 52.9 mass % of SiO₂, 16 mass % of Al₂O₃, 15.8 mass % of B₂O₃, 3.4 mass % of K₂O, 1.5 mass % of CaO, 1.5 mass % of ZnO, 1.2 mass % of TiO₂, 3.9 mass % of Nb₂O₅, and 3.8 mass % of WO₃. The resulting raw material batch was melted at 1580 to 1600° C. until it became homogeneous, the molten raw material batch was poured between a pair of rollers and formed into the shape of a film, and a glass material was obtained. The resulting glass material was ground by a grinder and then ground by a jet mill, resulting in glass particles (average particle size: 5 μm, glass transition temperature: 630° C.). Note that, the Fe content in the resulting glass particles was measured by X-ray fluorescence analysis, and the result was 50 ppm as calculated as Fe₂O₃.

The resulting glass particles were fed into a furnace using a table feeder and heated at from 1400° C. to 2000° C. using an air burner to soften and fluidize the glass particles, thereby spheroidizing the glass particles. The spheroidized glass particles were subjected to a heat treatment in the atmosphere at the temperatures described in Table 1. This resulted in glass particles No. 1 to No. 5. For each of the resulting glass particles, the Ti³⁺ content was evaluated using an ESR (Electron Spin Resonator). The results are shown in Table 1.

TABLE 1

| | No. 1 | No. 2 | No. 3 | No. 4 | No. 5 |
|---|---|---|---|---|---|
| Heat Treatment | 600 | 500 | 450 | 400 | None |
| Temperature | | | | | |
| (° C.) | | | | | |
| T³⁺ Content | 0.4 | 14 | 23 | 59 | 84 |
| (ppm) | | | | | |
| T³⁺/Total Ti | 0.00003 | 0.00117 | 0.00192 | 0.00492 | 0.007 |

### Production of Resin Composition

The glass particles and a UV-curable resin (DL360 available from Digital Wax) were mixed using a planetary centrifugal mixer, resulting in resin compositions. Note that the contents of the glass particles in the resin compositions were 35 vol %.

The resulting resin compositions were cured by irradiation with UV (wavelength 405 nm) and processed, resulting in molded bodies having a thickness of 2.5 mm. The resulting molded bodies were placed in a horizontally placed integrating sphere unit, and light transmittances were measured using a spectrophotometer V-670 available from JASCO Corporation. The resulting light transmittance curves are presented in the FIGURE.

The FIGURE reveals that the cured products using the glass particles of No. 1 to No. 4, which are Examples, have superior light transmittance compared to that of the cured product using the glass particles of No. 5, which is Comparative Example.

1: A glass comprising a Ti component in a glass composition, wherein a Ti³⁺ ion content is 80 ppm or less.

2: The glass according to claim 1, wherein the Ti component comprises TiO₂ in an amount of 0.1 mass % or greater.

3: The glass according to claim 1, further comprising an Fe component.

4: The glass according to claim 3, comprising the Fe component in an amount of 10 ppm or greater as calculated as Fe₂O₃.

5: The glass according to claim 1, comprising from 30 to 80 mass % of SiO₂, from 0 to 30 mass % of Al₂O₃, from 0 to 30 mass % of B₂O₃, from 0 to 25 mass % of CaO, from 0 to 30 mass % of Na₂O, from 0 to 30 mass % of K₂O, from 0 to 10 mass % of Li₂O, from 0.1 to 15 mass % of TiO₂, from 0 to 20 mass % of Nb₂O₅, from 0 to 20 mass % of WO₃, and from 0 to 10 mass % of F.

6: The glass according to claim 1, which is particulate.

7: The glass according to claim 6, which is substantially spherical.

8: The glass according to claim 6, having an average particle size from 0.5 to 50 μm.

9: A manufacturing method of a glass, which is a method for manufacturing the glass according to claim 1, the manufacturing method comprising:
preparing a precursor glass by melting raw materials and forming; and
heat-treating the precursor glass at a temperature within ±300° C. of a glass transition point.

10: A resin composition comprising a curable resin and the glass according to claim 1.

11: The resin composition according to claim 10, comprising from 1 to 70 vol % of the glass.

12: The resin composition according to claim 10, which is for dental use.

13: A molded body comprising a cured product of the resin composition according to claim 10.

14: A manufacturing method of a molded body, the manufacturing method comprising curing a resin composition by irradiating a light beam to the resin composition, wherein the resin composition is the resin composition according to claim 10.

15: A manufacturing method of a molded body, the method comprising:
forming a cured product layer by selectively irradiating a light beam to a liquid layer made of a resin composition, the cured product layer having a predetermined pattern;
after forming a new liquid layer on the cured product layer, forming a new cured product layer by irradiating the light beam to the new liquid layer, the new cured product layer having a predetermined pattern continuous with the cured product layer; and
repeating stacking of the cured product layers until a predetermined molded body is produced,
wherein the resin composition is the resin composition according to claim 10.
